(19) United States
(12) Patent Application Publication
(10) Pub. No.: US 2012/0100050 A1
(43) Pub. Date: Apr. 26, 2012

(54) PRODUCTION OF CALCINED LIME FROM NATURAL CHALK MATERIAL IN A ROTARY KILN

(76) Inventors: Michael Edward Prokesch, Coopersburg, PA (US); Charles Euston, Hamburg, PA (US)

(21) Appl. No.: 12/910,190

(22) Filed: Oct. 22, 2010

(51) Int. Cl. C01F 11/06

(52) U.S. Cl. 423/177; 423/175

(57) ABSTRACT

Disclosed is a method for calcining a natural chalk powder within a rotary kiln. The powder is inserted into the kiln accompanied by an additive that promotes nodulization of the powder to thereby facilitate the treatment of the chalk powder within the rotary kiln.

The nodulization takes place at temperatures less than the calcining temperatures of the chalk and prior to the nodulized chalk being calcined within the kiln.

### FIELD OF THE INVENTION

The present invention is broadly concerned with processing naturally occurring chalk or a fine limestone material into a lime product.

### BACKGROUND OF THE INVENTION

There are vast deposits of naturally occurring chalk in Russia, the northwestern part of Europe and in South America, such as Peru. Such chalk is composed mostly of calcium carbonate with minor amounts of silt and clay, and is potentially an excellent material for the production of lime. Unlike limestone, the normal feed for lime production, such naturally occurring chalk is typically characterized by a fine grain size on the order of several microns. This grain size makes it disadvantageous to process the chalk in normal limestone processing systems such as shaft kilns and long kilns, where, for example, in the latter processing naturally occurring chalk using normal processing techniques results in extremely dusty conditions while consuming large amounts of fuel.

In addition, attempts at utilizing gas suspension calciners that are designed specifically to handle fine grain materials have also been unsuccessful due to the poor flow properties of the fine chalk grains at elevated temperatures during the conversion to calcium oxide.

This chalk exhibits very high reactivity such that the recarbonization (CaO+CO2→CaCO3) in the upper stages of a gas suspension system yields catastrophic buildup in the preheater preventing continuous stable operation.

It is an object therefore of the present invention to produce a lime product from natural chalk that is suitable for lime markets.

### BRIEF DESCRIPTION OF THE INVENTION

The above and other objectives are generally achieved by producing a granulated or nodulized lime product utilizing a rotary kiln. The resulting product is suitable for the vast majority of existing lime markets.

The present invention utilizes chalk processing steps that include drying, preheating, agglomeration, calcination and cooling to form from a micron sized chalk starting material a granulated or nodulized lime product having a preferred diameter top size ranging from about 3 mm to about 50 mm, and most preferably from about 6 mm to about 20 mm that is suitable for further processing. Ultimately, it is understood that the desired size or size range of the granulated lime product will be determined by the practitioner of the invention, and increasing the amount of additive material used according to the invention will increase the top size of the granulated lime product. Numerous equipment configurations can be utilized to perform the above steps but all rely on a rotary kiln to support the high temperature agglomeration and calcination. The rotary kiln, if sufficiently sized, can support all of the processing steps except the cooling step. Alternatively and preferably the drying and all or a portion of the preheating of the natural chalk starting material may be performed outside of a rotary kiln to reduce the required rotary kiln size.

The natural chalk material is introduced to the rotary kiln along with a comparatively small quantity of an additive material comprising of an alkali metal salt or an alkaline metal salt or a compound demonstrating similar behavior as described further that serves to promote nodulization of the chalk. The chalk nodules undergo final calcination in the rotary kiln and are then discharged into a cooling device.

The alkali or alkaline metal salt additive has the property of becoming sticky prior to melting, and further of becoming sticky at temperatures below the temperature at which the calcination of the chalk will commence. The calcination temperature of the natural chalk will vary according to the desired final product properties, but will generally range from about 900° C. to about 1100° C.

The stickiness of the alkali or alkaline metal salt will promote, at suitable temperatures, the agglomeration of the chalk grains to produce larger nodules. In addition it has been discovered that the alkali or alkaline metal salt further promotes agglomeration of the natural chalk in a rotary kiln environment in that under normal operating conditions a portion of the additive material will vaporize under the kiln flame, travel in counter-current direction to the direction of movement of the chalk material through the kiln to a cooler portion of the kiln (typically the preheating portion of the kiln). Upon entering the cooler portion of the kiln, the alkali vapor condenses onto the surfaces of the chalk solids, thereby enabling further contribution to the nodulization process and minimizing the quantity of additive material that must be used.

### DESCRIPTION OF THE DRAWING

FIG. 1 depicts pertinent portions of a natural chalk processing system according to the present invention.

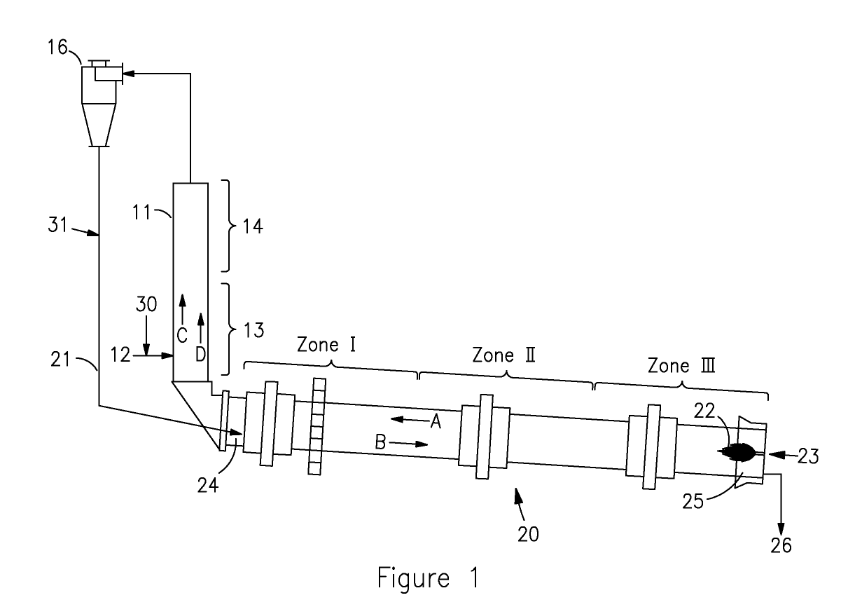

### DETAILED DESCRIPTION OF THE INVENTION

With reference to the Figure, natural chalk to be processed is fed to optional dryer and preheater 11 via a feeder such as feed screw 12. The function of dryer and preheater 11 may be alternately performed by the rotary kiln. In the presently depicted embodiment, dryer and preheater 11 is a flash dryer, although other preheating systems such as a hammer mill dryer may be utilized. Dryer and preheater 11 has an initial chalk drying area 13 and a subsequent chalk preheating area 14. The chalk material is fed into the bottom of flash dryer's shaft via feed screw 12 and is carried upwards (moving in the direction of arrow C) in the hot drying gas (moving in the direction of arrow D), which in the present case is exhaust gas from rotary kiln 20, although exhaust gas from another thermal process may be utilized or alternatively the hot gas can be produced in a combustion chamber. The flash dryer thoroughly disperses the material in the hot gas. The predried natural chalk entrained in a preheating gas is directed to an optional first separator 16, which is preferably a cyclone type separator, which is configured to separate the predried chalk from the preheating gas. The separated chalk is thereafter directed to rotary kiln 20 via conduit 21. The separated preheating gas, in which there may be entrained chalk dust, is directed to an optional second separator (not shown) such as a baghouse or electrostatic precipitator, to separate the dust from the gas and direct the separated dust to rotary kiln 20.

Natural chalk treated by the instant process typically consists of minute individual calcite crystals in the order of 1 micron or less in size. Chalk is a form of carbonate rocks containing 97.5-98.5 wt % calcium carbonate. The instant process can be used on other fine, primarily (>80 wt %) calcium carbonate, limestone materials containing a significant fine fraction (at least 90 wt % of the total material) of material that has a diameter of less than 1 mm-specifically lime kiln dust exhausted from a lime kiln.

The process of the present invention can also be utilized to calcine other limestone material that previously was not easily processed. For example, limestone screening fines is a waste material from a lime manufacturing process that typically contains about 95 wt % of material having a diameter of 6 mm or less. This material is not easily calcined because it also contains a quantity (at least 10 wt percent) of fines material that has a diameter of less than 74 microns resulting in extremely dusty conditions under normal processing techniques. The process of the present invention will granulize limestone screening fines containing a fines fraction thereby allowing for efficient calcination of these fines in a rotary kiln.

In the rotary kiln the chalk moves from material inlet 24 to material outlet 25 in counter-current direction to the direction of movement of the hot gases in the kiln, the movement of the gas and material being shown by arrows A and B respectively. The hot gases are generated by flame 22 inside the kiln, which in turn is generated by fuel that enters the kiln at point 23. A rotary kiln is well known in the art, and is a cylindrical vessel, inclined slightly to the horizontal, and rotated slowly about its axis. The material to be processed is fed into the upper material entry end of the cylinder. As the kiln rotates, material gradually moves down towards the lower material exit end, and in the process will undergo a certain amount of stirring and mixing.

In the rotary kiln utilized in the present invention there may be up to four temperature zones or areas: a drying zone, a preheating zone, a transition/nodulization zone and a calcining zone, with the transition/nodulization zone and the calcining zone being necessary to the present invention. In the depicted embodiment of the invention there are three zones:
Zone I, in which the temperature in a chalk process will range from about 225° C. to about 700° C., is the preheating zone. To a certain extent the dimensions of the preheating area can be shortened, or as indicated above eliminated, depending on the extent of material preheating, if any, that takes place external to the kiln.
Zone II, in which the temperature in a chalk process will range from about 700° C. to about 900° C., is the transition/nodulization area. Through the use of selected additives in the chalk calcining process, as described below, the nodulization of the chalk particles will take place in this area of the kiln.
Zone III, in which the temperature in a chalk process will range from about 900° C. to about 1100° C., is the calcination area in which the rapid calcination of chalk to form calcium oxide begins. The calcined material is then directed to a cooler (not shown) such as a grate cooler or an attached tube cooler.

The calcination of natural chalk in a rotary kiln is greatly facilitated and in fact made practical by nodulizing the natural chalk during the course of its treatment in the rotary kiln in the presence of a specified additive. The additive is preferably added by homogeneously mixing it to the chalk material, either with the feed prior to entry into the kiln, such as inserting the additive into material feed screw 12 at point 30 so that it mixes with the chalk material prior to the chalk entering the dryer/preheater 11, or at an earlier point in the process, such as at point 31 wherein the additive is inserted into the feed conduit leading directly into the kiln. The additives that are utilized in the present invention to promote nodulization of the chalk must not be harmful to the properties of the end lime material or have significant environmental drawbacks. Moreover, these additives must have the property of becoming sticky, viscous, or tacky (hereafter “sticky”) at temperatures that are less than the rapid calcination temperatures of the natural chalk, and more specifically at temperatures below, preferably about 50° C. to about 200° C. below, the temperatures at which rapid calcination of the chalk material commences. The additives are preferably alkali metal or alkaline earth metal salts, more preferably sodium or potassium salts and most preferably sodium carbonate. The additives are generally added to/combined with the chalk in an amount that generally ranges from about 0.05 wt % to about 0.5 wt %, and most preferably about 0.2 wt % to about 0.5 wt %, based on the weight of the natural chalk being added to the kiln. The size of the end granules is controlled by the amount of additive utilized. Although amounts above about 0.5 wt % of the additive may be used, larger amounts may promote the formation of ever increasingly larger granules of chalk and may also contribute to the formation of coatings in the kiln.

The additive will tend to become sticky in Zone II, the transitional area of the kiln, where it starts to promote nodulization of the chalk material. The majority of the additives will be incorporated with and will exit the kiln with the lime product. However, typically a very small amount of the additive will vaporize near the flame end of the kiln. The vaporized additive will be carried by the heating gases through the kiln in a direction counter-current to the movement of the material through the kiln and will recondense on the material in the lower temperature environment of Zone I, the preheating area, thereby forming a partial circulation of the alkali to improve its distribution and effectiveness for agglomeration.

In rotary kiln 20 natural chalk in primarily powder form is fed into the kiln at elevated material feed end 24 and the process heat enters at lower material exiting end 25. As the chalk moves through the kiln due to its rotation and the effects of gravity, it passes through three distinct areas within the kiln which are temperature dependent and progress in sequence from the coolest to the hottest area of the kiln, namely, initial preheating Zone I, transition area Zone II and calcination area Zone III. The calcined material will exit at lower end 25 as product 26 and is transferred to a cooler (not shown). Typical rotary kiln production rates will range from 200 mtpd to 1600 mtpd.

The residence time of the chalk material in the kiln will typically range between 1 and 3 hours.

1. A method for nodulizing and calcining a calcium carbonate material to form a nodulized calcium oxide product within a rotary kiln having a solid charging end and a solid exit end comprising:
inserting the material and an additive that promotes nodulization of the material into the kiln at the solid charging end;
directing the material and the additive to an area within the kiln having temperatures at which the additive becomes sticky and promotes nodulization of the material;
directing the nodulized material to an area within the kiln having temperatures at which there is rapid calcination in the nodulized material to form calcium oxide; and
discharging the calcined calcium oxide nodules from the kiln at solids exit end.

2. The method of claim 1 wherein the nodulization takes place at a temperature that ranges from about 50° C. to about 200° C. less than the temperature at which the material undergoes rapid calcination.

3. The method of claim 1 wherein the material and the additive are homogenously mixed prior to being inserted into the kiln.

4. The method of claim 1 wherein the material is first directed to a preheating area of the kiln that is adjacent to the solids charging end of the kiln wherein the material is heat treated at temperatures less than the temperatures in the area of the kiln in which nodulization occurs.

5. The method of claim 1 wherein the material is first dried in a drying area of the kiln that is adjacent to the solids charging end of the kiln and thereafter preheated in a preheating area of the kiln .

6. The method of claim 1 wherein the additive is an alkali metal or alkaline earth metal salt.

7. The method of claim 6 wherein the additive is a sodium or potassium salt.

8. The method of claim 7 wherein the additive is sodium carbonate.

9. The method of claim 8 wherein the additive is added to the material in an amount that ranges from about 0.05 wt % to about 0.5 wt %, based on the weight of the material [natural chalk] being added to the kiln.

10. The method of claim 9 wherein the additive is added to the material in an amount that ranges from about 0.2 wt % to about 0.5 wt %.

11. The method of claim 1 wherein the material is natural chalk powder.

12. The method of claim 1 wherein the material is lime kiln dust exhausted from a lime kiln.

13. A method for nodulizing and calcining limestone screening fines that contain about 10 wt % of material having a diameter of 74 microns or less within a rotary kiln having a solid charging end and a solid exit end comprising:
inserting at the solid charging end of a rotary kiln the limestone screening fines and an additive that promotes nodulization of the limestone screening fines;
directing the fines and the additive through the kiln to the an area having temperatures at which the additive becomes sticky and the nodulization takes place;
directing the nodulized fines through the kiln to the an area having temperatures at which the rapid calcination of the nodulized fines takes place; and
discharging the calcined nodules from the kiln at solids exit end.
